(19) United States
(12) Patent Application Publication
(10) Pub. No.: US 2026/0190119 A1
(43) Pub. Date: Jul. 2, 2026

(54) SYSTEM INFORMATION TRANSMISSION METHOD, COMMUNICATION APPARATUS AND COMMUNICATION DEVICE

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/859,722

(22) PCT Filed: Apr. 29, 2022
(86) PCT No.: PCT/CN2022/090488

§ 371 Date: Oct. 24, 2024

(51) Int. Cl. H04W 72/231; H04W 72/0457; H04W 72/12; H04W 76/20; H04W 80/02

(52) U.S. Cl. CPC H04W 72/231; H04W 72/0457; H04W 72/12; H04W 76/20; H04W 80/02

(57) ABSTRACT

Provided in the embodiments of the present disclosure are a system information transmission method, a communication apparatus, and a communication device. The system information transmission method may include: configuring, by a network device, a first system information (SI) message, wherein the first SI message comprises a plurality of system information blocks (SIBs); and sending, by the network device, some of the SIBs in the first SI message.

### CROSS-REFERENCE TO RELATED APPLICATION

The present application is a National Stage of International Application No. PCT/CN2022/090488, filed on Apr. 29, 2022, the entire disclosure of which is incorporated herein by reference for all purposes.

### TECHNICAL FIELD

The present disclosure relates to the field of wireless communication technology, and in particular to a system information transmission method, a communication apparatus and a communication device.

### BACKGROUND

In a new radio (NR) system, a system information (SI) message may include one or more system information blocks (SIBs).

At present, when a network device (such as a base station) broadcasts system information, it broadcasts with the SI message as the smallest unit. That is, when broadcasting system information, the SI message is broadcast as a whole, that is, all SIBs contained in a SI message are broadcast at the same time.

### SUMMARY

The present disclosure provides a system information transmission method, a communication apparatus and a communication device.

According to a first aspect of the present disclosure, a system information transmission method is provided, which can be applied to the network device side of a communication system. The method may include: configuring, by a network device, a first system information (SI) message, wherein the first SI message includes a plurality of system information blocks (SIBs); and sending, by the network device, a part of the SIBs in the first SI message.

According to a second aspect of the present disclosure, a system information transmission method is provided, which can be applied to the terminal device side of the communication system. The method may include: receiving, by a terminal device, at least one SIB sent by a network device, wherein the at least one SIB is a part of SIBs in a second SI message, and the second SI message is SI containing a plurality of SIBs configured by the network device.

According to a third aspect of the present disclosure, a communication apparatus is provided. The communication apparatus may be a network device in a communication system or a chip or system-on-chip in the network device, or a functional module in the network device for implementing the methods of the above-mentioned embodiments. The communication apparatus may implement the functions performed by the network device in the above-mentioned embodiments, and these functions may be implemented by hardware executing corresponding software. These hardware or software includes one or more modules corresponding to the above-mentioned functions. The communication apparatus includes: a processing module, configured to configure a first SI message, wherein the first SI message includes a plurality of SIBs; a transmission module, configured to send a part of the SIBs in the first SI message.

According to a fourth aspect of the present disclosure, a communication apparatus is provided, which can be a terminal device in a communication system or a chip or system-on-chip in the terminal device, and can also be a functional module in the terminal device for implementing the methods of the above-mentioned embodiments. The communication apparatus can implement the functions performed by the terminal device in the above-mentioned embodiments, and these functions can be implemented by hardware executing corresponding software. These hardware or software includes one or more modules corresponding to the above-mentioned functions. The communication apparatus includes: a transmission module, configured to receive at least one SIB sent by a network device, wherein the at least one SIB is a part of SIBs in a second SI message, and the second SI message is SI containing a plurality of SIBs configured by the network device.

According to a fifth aspect of the present disclosure, a communication device is provided, such as a network device, including: an antenna; a memory; and a processor, connected to the antenna and the memory respectively, configured to control transmission and reception of the antenna by executing computer executable instructions stored on the memory, and capable of implementing the system information transmission method as in the first aspect and any one of its exemplary implementations of the present disclosure.

According to a sixth aspect of the present disclosure, a communication device is provided, such as a terminal device, including: an antenna; a memory; and a processor, connected to the antenna and the memory respectively, configured to control transmission and reception of the antenna by executing computer executable instructions stored on the memory, and capable of implementing the system information transmission method as in the second aspect and any one of its exemplary implementations of the present disclosure.

According to a seventh aspect of the present disclosure, a computer storage medium is provided. The computer storage medium stores computer executable instructions, wherein the computer executable instructions can be executed by the processor to implement the system information transmission method as in the first aspect, the second aspect and any one of their exemplary implementations of the present disclosure.

According to an eighth aspect of the present disclosure, a computer program or a computer program product is provided. When the computer program product is executed on a computer, the computer implements the communication method described in the first aspect, the second aspect and any exemplary implementations thereof.

It should be understood that the technical solutions of the third to seventh aspects of the present disclosure are consistent with those of the first to second aspects of the present disclosure, and the beneficial effects achieved by each aspect and the corresponding feasible implementations are similar, and will not be repeated.

### BRIEF DESCRIPTION OF THE DRAWINGS

FIG. 1 is a schematic diagram of the structure of a communication system in an embodiment of the present disclosure;

FIG. 2 is a schematic diagram of the implementation process of the first system information transmission method in an embodiment of the present disclosure;

FIG. 3 is a schematic diagram of the implementation process of the second system information transmission method in an embodiment of the present disclosure;

FIG. 4 is a schematic diagram of the implementation process of the third system information transmission method in an embodiment of the present disclosure;

FIG. 5 is a schematic diagram of the implementation process of the fourth system information transmission method in an embodiment of the present disclosure;

FIG. 6 is a schematic diagram of the implementation process of the fifth system information transmission method in an embodiment of the present disclosure;

FIG. 7 is a schematic diagram of the structure of a communication apparatus in an embodiment of the present disclosure;

FIG. 8 is a schematic diagram of the structure of a communication device in an embodiment of the present disclosure;

FIG. 9 is a schematic diagram of the structure of a terminal device in an embodiment of the present disclosure; and

FIG. 10 is a schematic diagram of the structure of a network device in an embodiment of the present disclosure.

### DETAILED DESCRIPTION

The example embodiments will be described in detail here, and examples thereof are shown in the accompanying drawings. When the following description refers to the drawings, unless otherwise indicated, the same numbers in different drawings represent the same or similar elements. The implementations described in the following example embodiments do not represent all implementations consistent with the embodiments of the present disclosure. Instead, they are merely examples of apparatuses and methods consistent with some aspects of the embodiments of the present disclosure as detailed in the attached claims.

The terms used in the embodiments of the present disclosure are only for the purpose of describing specific embodiments and are not intended to limit the embodiments of the present disclosure. The singular forms of “a” and “the” used in the embodiments of the present disclosure and the appended claims are also intended to include plural forms unless the context clearly indicates other meanings. It should also be understood that the term “and/or” used herein refers to and includes any or all possible combinations of one or more related listed items.

It should be understood that although the terms “first”, “second”, “third”, etc. may be used to describe various information in the embodiments of the present disclosure, these information should not be limited to these terms. These terms are only used to distinguish the same type of information from each other. For example, without departing from the scope of the embodiments of the present disclosure, “first information” may also be referred to as “second information”, and similarly, “second information” may also be referred to as “first information”. Depending on the context, the word “if” as used herein can be interpreted as “at . . . ” or “when . . . ” or “in response to determining”.

The technical solution provided by the embodiments of the present disclosure can be applied to wireless communication between communication devices. The wireless communication between communication devices may include: wireless communication between network devices and terminal devices, wireless communication between network devices and network devices, and wireless communication between terminal devices and terminal devices. In the embodiments of the present disclosure, the term “wireless communication” may also be referred to as “communication”, and the term “communication” may also be described as “data transmission”, “information transmission” or “transmission”.

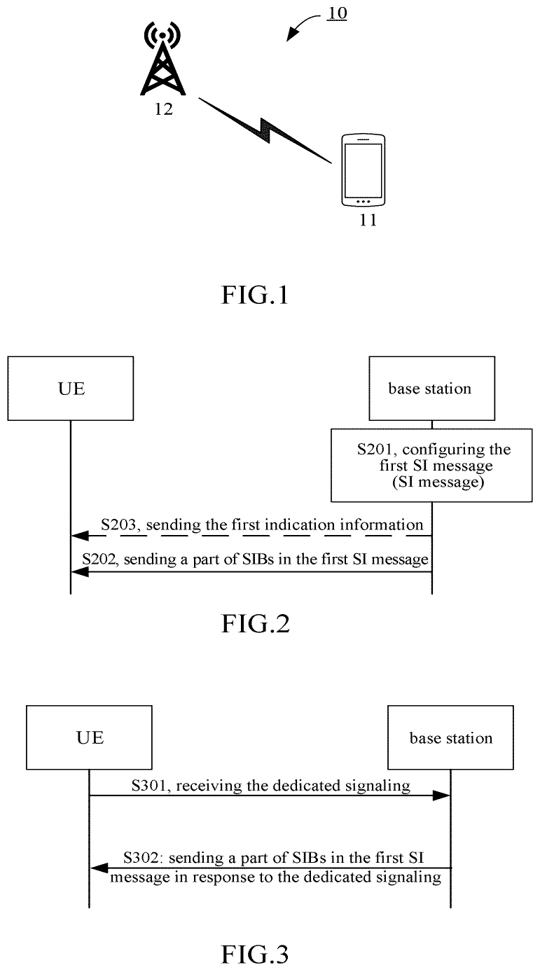

The embodiments of the present disclosure provide a communication system. The communication system may be a communication system using cellular mobile communication technology. FIG. 1 is a schematic diagram of the structure of a communication system in the embodiments of the present disclosure. As shown in FIG. 1, the communication system 10 may include: a terminal device 11 and a network device 12.

In one embodiment, the terminal device 11 may be a device that provides voice or data connectivity to a user. In some embodiments, the terminal device may also be referred to as the user equipment (UE), the mobile station, the subscriber unit, the station or the terminal equipment (TE), etc. The terminal device may be a cellular phone, a personal digital assistant (PDA), a wireless modem, a handheld device, a laptop computer, a cordless phone, a wireless local loop (WLL) station or a tablet computer (pad), etc. With the development of wireless communication technology, devices that can access the communication system, communicate with the network side of the communication system, or communicate with other devices through the communication system are all terminal devices in the embodiments of the present disclosure, for example, terminals and cars in intelligent transportation, household appliances in smart homes, power meter reading instruments in smart grids, voltage monitoring instruments, environmental monitoring instruments, video monitoring instruments in intelligent complete networks, cash registers, etc. In the embodiments of the present disclosure, the terminal device can communicate with the network device, and a plurality of terminal devices can also communicate with each other. The terminal device can be statically fixed or mobile.

The above-mentioned network device 12 can be a device on the access network side for supporting the terminal to access the communication system. For example, it can be an evolved NodeB (eNB) in a 4G access technology communication system, a next generation base station (next generation nodeB, gNB) in a 5G access technology communication system, a transmission reception point (TRP), a relay node, an access point (AP), etc.

In the NR system, the system information (SI) consists of a main information block (MIB) and several SIBs, which is divided into minimum SI and other SI.

The above minimum SI includes the basic information required for initial access and the information for obtaining any other SI.

The minimum SI includes:
the MIB contains cell forbidden status information and basic physical layer information of the cell required to receive further system information, such as the control resource set (CORESET #0) configuration. The MIB is broadcast periodically on the broadcast channel.

SIB1 defines the scheduling of other SIBs and contains information required for initial access. SIB1 is also called the remaining minimum SI (RMSI), which is broadcast periodically on the downlink shared channel (DL-SCH) or sent in a dedicated manner on the DL-SCH to the terminal device (such as UE) in the connected state (RRC_CONNECTED).

The above other SI includes all SIBs (which can be recorded as SIBn) that are not broadcast in the minimum SI. SIBn can be broadcast periodically on DL-SCH, broadcast on-demand on DL-SCH (i.e., based on the request of the UE in an idle state (RRC_IDLE) or a deactivated state (RRC_INACTIVE)), or sent to the UE in RRC_CONNECTED on DL-SCH through the dedicated signaling (such as the RRCReconfiguration message) (i.e., based on the request of the UE in RRC_CONNECTED or the UE with an active band width part (BWP) not configured with common search space).

Other SIs include: SIB2 to SIB21 and SIBpos.

SIB2 contains cell reselection information, mainly related to the serving cell.

SIB3 contains information about the serving frequency and co-frequency neighboring cells related to cell reselection.

SIB4 contains information about other NR frequencies and inter-frequency neighboring cells related to cell reselection.

SIB5 contains information about evolved universal terrestrial radio access (E-UTRA) frequency and E-UTRA neighboring cells related to cell reselection.

SIB6 contains an earthquake and tsunami warning system (ETWS) primary notification.

SIB7 contains an ETWS secondary notification.

SIB8 contains a commercial mobile alert service (CMAS) warning notification.

SIB9 contains information related to global positioning system (GPS) time and coordinated universal time (UTC).

SIB10 contains human readable network name (HRNN) of non-public network (NPN) listed in SIB1.

SIB11 contains information related to idle/inactive measurements.

SIB 15 contains information related to disaster roaming.

SIB17 contains information related to the tracking reference signal (TRS) configuration of the UE in RRC_IDLE or RRC_INACTIVE.

SIBpos contains positioning assistance data;

SIB18 contains information related to the group ID for network selection (GIN), the group ID is associated with the stand-alone NPN (SNPN) in a stand-alone mode listed in SIB1.

For sidelink, other SIs also include:
SIB12 contains information related to NR sidelink communication.
SIB 13 contains information related to SystemInformationBlockType21 for vehicle to everything (V2X) sidelink communication.
SIB14 contains information related to SystemInformationBlockType26 for V2X sidelink communication.

For non-terrestrial network (NTN), other SI also includes:
SIB19 contains NTN-specific parameters for the serving cell and/or neighboring cells.

For multicast/broadcast services (MBS) broadcast, other SIs also include:
SIB20 contains MBS control channel (MCCH) configuration.
SIB21 contains information about service continuity of MBS broadcast reception.

In the above communication system, when the network device (base station) broadcasts system information, it broadcasts with the SI message as the smallest unit. Then, for one or several SIBs whether scheduled by the base station itself or requested by the UE, the base station broadcasts in the unit of the SI message. For example, the UE requests SIB12, SIB13 and SIB14, the base station will send a SI message containing SIB12, SIB13 and SIB14 to the UE. The SI message will also contain other SIBs. Then, the UE will receive SIBs other than its own. It can be seen that the base station will transmit unnecessary SIBs, resulting in waste of resource and increased power consumption of the device.

In order to solve the above problems, the embodiment of the present disclosure provides a system information transmission method, which can be applied to the network device of the above communication system.

First, it should be noted that the network device described in the embodiments of the present disclosure can be described by taking a base station as an example, and the terminal device can be described by taking UE as an example.

Further, the “SIB” described in the embodiments of the present disclosure can be understood as the above-mentioned other SIBs (i.e., SIBn), and can also include other SIBs that evolve with the evolution of the communication system, i.e., new SIBs (hereinafter referred to as new-SIB) that appear in the evolved version of the 3rd Generation Partnership Project (3GPP) protocol.

FIG. 2 is a schematic diagram of the implementation flow of the first system information transmission method in the embodiment of the present disclosure. As shown by the solid line in FIG. 2, the method may include following steps.

S201, the base station configures the first SI message (SI message).

The first SI message (or the second SI message) includes a plurality of SIBs. The plurality of SIBs may include one or more of the above-mentioned SIBn, or one or more of the new-SIB.

In practical applications, SI can be divided into two types according to the broadcast status (SI-broadcaststatutes), the first type is periodic broadcast. For SI messages whose broadcast status is set as broadcasting (i.e., SI-broadcaststatutes=broadcasting), the base station can always broadcast such SIBs at a fixed period. The second type is non-periodic broadcast. For SI messages whose broadcast status is set as non-broadcasting (i.e., SI-broadcaststatutes=notbroadcasting), the base station can send such SIBs to the UE on demand (on-demand).

Optionally, the base station can configure the broadcast status of SI in SIB1. The UE can determine the sending manner of the first SI according to the broadcast status in SIB1.

In some possible implementations, the broadcast state of the first SI message is configured as non-broadcasting. At this time, the first SI message may include SIBn and new-SIB.

In some possible implementations, the broadcast state of the first SI message is configured as broadcasting. At this time, the first SI message may include new-SIB, that is, the first SI message includes SIBs other than SIB2 to SIB21 and SIBpos.

S202, the base station sends a part of the SIBs in the first SI message.

It should be understood that, when configuring the first SI message through S201, the base station can configure a SI message to include a plurality of SIBs. However, when the base station executes S202, it can send a part of the configured plurality of SIBs when sending the first SI message, instead of sending the entire first SI message, to avoid transmitting unnecessary SIBs, reduce system resource overhead, and reduce power consumption of the base station.

In some possible implementations, when executing S202, the base station can use the following two manners to transmit a part of the SIBs in the first SI message.

The first manner is that the base station broadcasts a part of the SIBs in the first SI message on the BCCH.

It should be understood that, the SIBs that the base station needs to broadcast periodically and/or the SIBs that are broadcast according to the request of UE can be broadcast on the BCCH (such as DL-SCH, or physical downlink shared channel (PDSCH).

The second manner is that the base station sends a part of the SIBs in the first SI message on the DCCH.

It should be understood that, a part of the SIBs in the first SI message sent by the base station through the dedicated signaling according to the request of UE can be broadcast on the DCCH.

FIG. 3 is a schematic diagram of the implementation flow of the second system information transmission method in the embodiment of the present disclosure. As shown in FIG. 3, when the base station sends the first SI message to the UE on demand, before S202, the above method may also include following steps.

S301, the base station receives the dedicated signaling (such as RRC dedicated signaling) sent by the UE.

The RRC dedicated signaling is used to request the first SIB (which can also be the second SI B), that is, the SIB requested by the UE.

In practical applications, the first SIB may include one or more SIBs.

Optionally, the UE requesting the SIB may be the UE in a connected state, the UE in an idle state, or the UE in a deactivated state.

Correspondingly, the above S202 may include:
S302: the base station sends a part of the SIBs in the first SI message to the UE in response to the dedicated signaling. At this time, the part of the SIBs includes the first SIB.

It should be understood that, the UE requests the first SIB from the base station. The base station selects the first SI message containing the first SIB from the configured SI messages, and sends at least the first SIB to the UE.

In some possible implementations, the base station may receive the dedicated signaling sent by a plurality of UEs, and broadcast SI messages containing SIBs requested by these UEs.

In one embodiment, when sending a part of the SIBs of the first SI message, the base station may also include other SIBs not requested by the UE (such as SIBs requested by other UEs) according to actual needs, but it is necessary to ensure that the number of the part of SIBs is smaller than the number of SIBs configured by the base station for the first SI message. This embodiment of the present disclosure does not specifically limit this.

In some possible implementations, after S302, the above method may also: the base station determines that common search space for transmitting SI is configured on the active BWP where the UE operates. Accordingly, S302 may include: the base station broadcasts a part of the SIBs containing the first SIB in response to the dedicated signaling.

It should be understood that, after receiving the dedicated signaling sent by the UE in S301, the base station can also first determine whether the active BWP where the UE operates is configured with common search space, and the UE can monitor the SI message in the common search space. If the base station determines that the active BWP of the UE is configured with common search space (which can also be described as the UE with an active BWP configured with common search space), at this time, the base station responds to the dedicated signaling and broadcasts a part of the SIBs containing the first SIB. Conversely, the base station sends a part of the SIBs containing the first SIB to the UE through the dedicated signaling.

Optionally, after S301, the base station can also confirm the broadcast status of the first SI message. If the broadcast status of the first SI message is configured as broadcasting, after the base station determines that the active BWP where the UE operates is configured with common search space for transmitting SI, the base station responds to the dedicated signaling and broadcasts a part of the SIBs containing the first SI message; conversely, the base station responds to the dedicated signaling and sends a part of the SIBs containing the first SI message to the UE through the dedicated signaling.

In some possible implementations, the base station sends a part of the SIBs of the first SI message to the UE in S202, and the base station needs to indicate to the UE the type of the actually sent SIB. Then, as shown by the dotted line in FIG. 2, before S202, the above method may include: S203, the base station sends the first indication information (which may also be the second indication information), and the first indication information is used to indicate the type of the part of the SIBs in the first SI message.

It can be understood that, the base station can configure the first indication information in the scheduling information of the first SI message. For example, the first indication information can be carried in the scheduling DCI of the first SI message, or the first indication information can be carried in the MAC CE. Here, the term “carry” can also be described as “bear”.

It should be understood that, for the UE in the idle state, deactivated state or connected state, the first indication information can be carried in the DCI. In particular, the first indication information is carried in the reserved field of the DCI. For the UE in the connected state, the first indication information can be carried in the MAC CE.

For example, Example 1, the first SI message configured by the base station includes SIB10, SIB12, SIB13 and SIB14, a total of 4 SIBs. In DCI 1-0, there are 4 bits used to indicate the type of SIB (i.e., a part of the SIB) actually transmitted in the scheduled first SI message, and each bit corresponds to one SIB type. If the 4 bits are 1100, it means that in the scheduled first SI message, only SIB10 and SIB12 are actually transmitted, and SIB13 and SIB14 are not transmitted.

Example 2, the first SI message configured by the base station includes SIB10, SIB12, SIB13 and SIB14, a total of 4 SIBs. In DCI 1-0, there are 2 bits used to indicate the type of SIB (i.e., a part of the SIB) actually transmitted in the scheduled first SI message. Each bit corresponds to two SIB types. If the 2 bits are 01, it means that in the scheduled first SI message, only SIB13 and SIB14 are actually transmitted, and SIB10 and SIB12 are not transmitted.

Example 3, the first SI message configured by the base station contains a total of 3 SIBs, namely SIB12, SIB12 and SIB14. The UE in the connected state requests SIB12, and the base station sends SIB12 to the UE by broadcasting the first SI message. When broadcasting the first SI message, the base station may only broadcast SIB12, without broadcasting SIB13 and SIB14.

Example 4, a SI message configured by the base station contains a total of 3 SIBs, namely SIB12, SIB13 and SIB14. The UE1 in the connected state requests SIB12, and the UE2 in the connected state requests SIB13. The base station sends SIB12 and SIB13 to UE1 and UE2 by broadcasting the first SI message. When broadcasting the first SI message, the base station may only broadcast SIB12 and SIB13, without broadcasting SIB14.

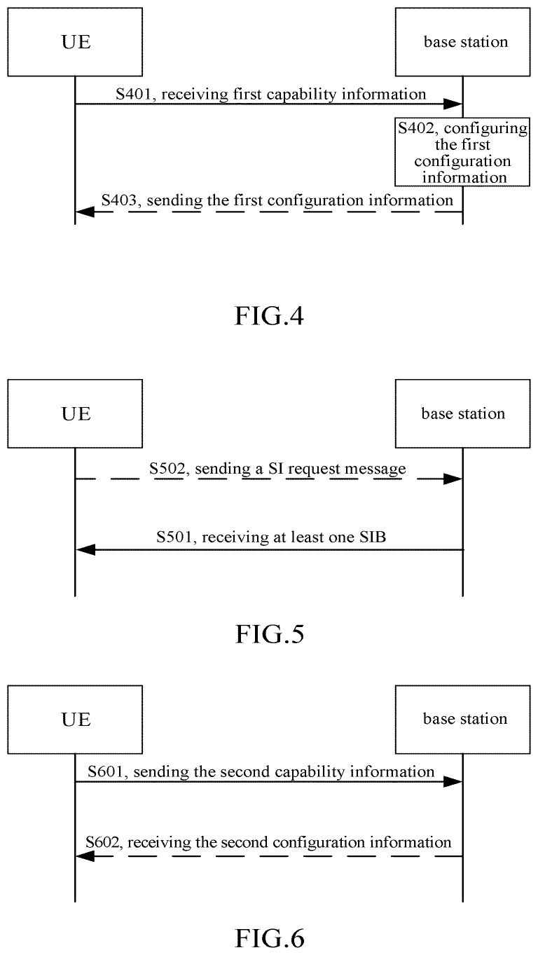

In some possible implementations, FIG. 4 is a schematic diagram of the implementation process of the third system information transmission method in the embodiment of the present disclosure. Referring to the solid line in FIG. 4, before S202, the method further includes following steps.

S401, the base station receives first capability information (or second capability information) from the UE, the first capability information is used to indicate that the UE supports the base station to send a part of the SIBs in the SI when sending the SI.

At this time, S202 may include: the base station sends a part of the SIBs in the first SI message to the UE in response to the first capability information.

It should be understood that, the UE determines whether to support the base station to send a part of the SIBs in the SI when sending the SI based on its own capability (such as processing capability, endurance capability, hardware performance, etc.), and sends the first capability information to the base station.

In one embodiment, the UE may only send the first capability information indicating that it supports the base station to send a part of the SIBs in the SI message when sending the SI message to the base station. At this time, when receiving the first capability information, the base station may determine that the UE supports sending a part of the SIBs in the SI message when sending the SI message, and vice versa, when the base station does not receive the first capability information, the base station may determine that the UE does not support sending a part of the SIBs in the SI message when sending the SI message.

In another embodiment, the UE may send the first capability information indicating that it supports the base station to send a part of the SIBs in the SI message when sending the SI message to the base station, and send the first capability information indicating that it does not support the base station to send a part of the SIBs in the SI message when sending the SI message to the base station. At this time, based on the first capability information, the base station can determine that the UE supports sending a part of SIBs in the SI message when sending the SI message or does not support sending a part of SIBs in the SI message when sending the SI message.

Further, the base station can also consider the first capability information of the UE, the broadcast status of the SI message, and whether the common search space for transmitting SI is configured on the active BWP where the UE operates, so as to determine whether to send a part of SIBs in the first SI message to the UE by broadcasting.

In some possible implementations, in addition to reporting the first capability information according to its own capability of the UE, the base station also needs to configure its own functions. Then, still referring to the dotted line in FIG. 4, before S202, the above method also includes:
S402, the base station configures the first configuration information (which can also be the second configuration information), and the first configuration information is used to indicate that the base station is allowed to send a part of SIBs in the SI message when sending the SI message. It can also be understood that, the base station configures itself whether it is allowed to send all SIBs in the SI message when sending the SI message.

It should be understood that, before S202, the base station can determine whether it is allowed to send a part of SIBs in the SI when sending the SI according to its own processing capability, performance parameter, power consumption, etc. If allowed, the base station executes S202 to send a part of the SIBs of the first SI message to the UE, otherwise, the base station sends all the SIBs of the first SI message.

Optionally, in S403, the base station sends the first configuration information to the UE, to inform the UE of the configuration of the base station, and then instructs the UE to receive the first SI message according to the first configuration information.

Further, the base station can also simultaneously consider the first capability information of the UE, the broadcast status of the SI message, whether the common search space for transmitting SI is configured on the active BWP where the UE operates, and its own first configuration information, so as to determine whether to send a part of SIBs in the first SI message to the UE in a broadcast manner.

So far, the transmission process of the system information on the base station side is completed.

In the embodiment of the present disclosure, the base station configures a SI message (i.e., the first SI message) containing a plurality of SIBs. When sending the first SI message, the base station only sends a part of the SIBs in the first SI message, so as to avoid transmitting unnecessary SIBs, reduce system resource overhead, and reduce power consumption of the base station.

Based on the same inventive concept, the embodiment of the present disclosure also provides a system information transmission method, which can be applied to the UE side in the above communication system.

FIG. 5 is a schematic diagram of the implementation flow of the fourth system information transmission method in the embodiment of the present disclosure, as shown by the solid line in FIG. 5, the method may include:
S501, UE receives at least one SIB sent by the base station.

The at least one SIB is part of the SIBs in the second SI message (i.e., a part of the SIBs in the first SI message).

It can be understood that, the UE can receive at least one SIB according to the scheduling information of the second SI message.

In some possible implementations, S501 may include: UE receives at least one SIB on BCCH; or, UE receives at least one SIB on DCCH.

In some possible implementations, the UE may request SIB from the base station on demand, then, still referring to the dotted line in FIG. 5, before S501, the above method may also include: S502, UE sends a SI request message (such as MGS1 or MSG3) to the base station.

The SI request message is used to request the network to send the second SIB (i.e., the first SIB).

Correspondingly, S501 may include: UE receives at least one SIB containing the second SIB, and at least one SIB is sent by the base station in response to the SI request information.

In actual applications, the SI request message is carried in the dedicated signaling, such as the RRC dedicated signaling.

In some possible implementations, the base station sends a part of the SIBs of the second SI message to the UE, and the base station needs to indicate to the UE the type of the actually sent SIB. Then, still referring to the dotted line in FIG. 5, the above method also includes: S503, the UE receives the second indication information (i.e., the first indication information) sent by the base station, and the second indication information is used to indicate the type of a part of the SIBs in the second SI message.

In actual applications, the second indication information is carried in the DCI for scheduling the second SI message. At this time, the UE can be in an idle state or a deactivated state. The UE can also be in a connected state. Optionally, the second indication information is carried in a reserved field of the DCI.

Further, the UE is in a connected state, and the second indication information is carried in the MAC CE.

In some possible implementations, FIG. 6 is a schematic diagram of the implementation process of the fifth system information transmission method in the embodiment of the present disclosure. As shown by the solid line in FIG. 6, before S501, the above method further includes:
S601, the UE sends the second capability information (i.e., the first capability information) to the base station, and the second capability information is used to indicate that the UE supports the base station to send a part of the SIBs in the SI message when sending the SI message.

It should be understood that, the UE determines whether to support the base station to send a part of the SIBs in the SI when sending the SI based on its own capability (such as processing capability, endurance capability, hardware performance, etc.), and sends the second capability information to the base station.

In one embodiment, the UE may only send the second capability information indicating that it supports the base station to send a part of the SIBs in the SI message when sending the SI message to the base station. At this time, when receiving the second capability information, the base station can determine that the UE supports sending a part of the SIBs in the SI message when sending the SI message. Conversely, when the base station does not receive the second capability information, the base station can determine that the UE does not support sending a part of the SIBs in the SI message when sending the SI message.

In another embodiment, the UE may send second capability information to the base station indicating that it supports the base station to send a part of SIBs in the SI message when sending the SI message, and send the second capability information to the base station indicating that it does not support the base station to send a part of SIBs in the SI message when sending the SI message. At this time, based on the second capability information, the base station may determine that the UE supports sending a part of SIBs in the SI message when sending the SI message or does not support sending a part of SIBs in the SI message when sending the SI message.

In some possible implementations, in addition to reporting the second capability information based on its own capability, the base station also needs to configure its own functions and inform the UE. Then, as shown by the dotted line in FIG. 6, before S501, the above method also includes:
S602, the UE receives the second configuration information (i.e., the first configuration information) from the base station, and the second configuration information is used to indicate that the base station is allowed to send a part of SIBs in the SI when sending the SI.

It can also be understood as whether the base station is allowed to send all SIBs in the SI message when sending the SI message.

It should be understood that, before S501, the base station can configure itself whether it is allowed to send a part of the SIBs in the SI when sending the SI according to its own processing capability, performance parameters, power consumption, etc., and send the second configuration information to the UE, thereby instructing the UE to receive the first SI message according to the first configuration information.

In one embodiment, the base station can only send the second configuration information indicating that a part of the SIBs in the SI message is allowed to be sent when sending the SI message to the UE. At this time, when the second configuration information is received, the UE can determine that the base station is allowed to send a part of the SIBs in the SI message when sending the SI message, and vice versa, when the second configuration information is not received, the UE can determine that the base station is not allowed to send a part of the SIBs in the SI message when sending the SI message.

In another embodiment, the base station can send the second configuration information indicating that a part of the SIBs in the SI message is allowed to be sent when sending the SI message to the UE, and send the second configuration information indicating that a part of the SIBs in the SI message is not allowed to be sent when sending the SI message to the UE. At this time, according to the second configuration information, the UE can determine that the base station is allowed to send a part of the SIBs in the SI message when sending the SI message or is not allowed to send a part of the SIBs in the SI message when sending the SI message.

So far, the transmission process of the system information on the UE side is completed.

It should be noted that the specific implementation process of transmitting system information on the UE side can refer to the specific description of transmitting system information on the base station side in the embodiments of FIGS. 2 to 4. For the sake of brevity, it will not be repeated here.

In the embodiment of the present disclosure, for a SI message (i.e., the first SI message) containing a plurality of SIBs configured by the base station, the UE can receive a part of the SIBs in the first SI message, so as to avoid transmitting unnecessary SIBs, reduce system resource overhead, and reduce power consumption of the base station.

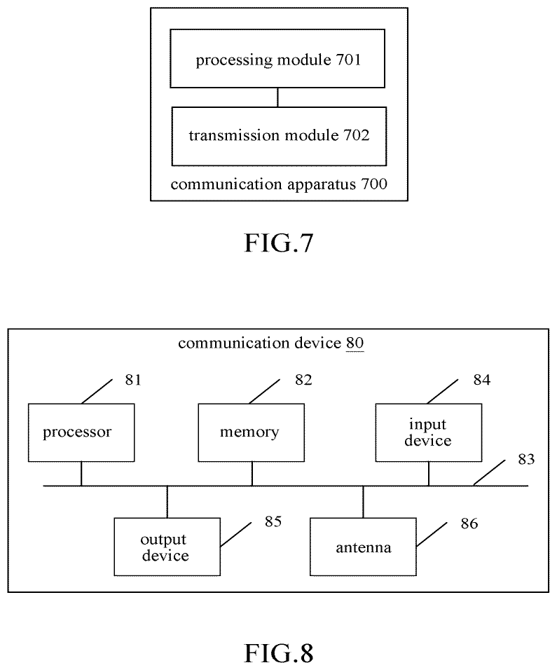

Based on the same inventive concept, the embodiment of the present disclosure provides a communication apparatus. FIG. 7 is a structural diagram of a communication apparatus in the embodiment of the present disclosure. As shown in FIG. 7, the communication apparatus 700 may include: a processing module 701 and a transmission module 702.

In some possible embodiments, the communication apparatus 700 may be a network device in a communication system (such as the base station described in the above embodiment) or a chip or system on chip in the network device, and may also be a functional module in the network device for implementing the methods of the above embodiments. The communication apparatus can implement the functions performed by the network device in the above embodiments, and these functions can be implemented by hardware executing corresponding software. These hardware or software includes one or more modules corresponding to the above functions.

Correspondingly, the processing module 701 is used to configure first system information (SI), wherein the first SI message includes a plurality of system information blocks (SIB); and a transmission module, configured to send a part of the SIBs in the first SI message.

In some possible implementations, the transmission module 702 is used to send first indication information, wherein the first indication information is configured to indicate a type of the part of the SIBs in the first SI message.

In some possible implementations, the first indication information is carried in downlink control information (DCI) configured to schedule the first SI message.

In some possible implementations, the first indication information is carried in a reserved field of the DCI.

In some possible implementations, the first indication information is carried in a control element of a media access control layer (MAC CE).

In some possible implementations, a broadcast state of the first SI message is configured as non-broadcasting.

In some possible implementations, the broadcast state of the first SI message is configured as broadcasting, and the first SI message includes SIBs other than SIB1 to SIB21 and a positioning SIB (SIBpos).

In some possible implementations, the part of the SIBs includes a first SIB, and the first SIB is a SIB requested by a terminal device in a connected state through a radio resource control (RRC) dedicated signaling.

In some possible implementations, the transmission module 702 is used to determine that common search space for transmitting SI is configured on an active band width part (BWP) where the terminal device operates; broadcast the part of the SIBs containing the first SIB in response to the RRC dedicated signaling.

In some possible implementations, the transmission module 702 is used to broadcast the part of the SIBs in the first SI message on a broadcast control channel (BCCH); or, the network device broadcasts the part of the SIBs in the first SI message on a dedicated control channel (DCCH).

In some possible implementations, the transmission module 702 is also used to receive first capability information from a terminal device before the part of the SIBs in the first SI message is sent, wherein the first capability information is configured to indicate that the terminal device supports the network device to send the part of the SIBs in the SI when sending the SI; send the part of the SIBs in the first SI message to the terminal device in response to the first capability information.

In some possible implementations, the processing module 701 is used to configure first configuration information before the transmission module sends the part of the SIBs in the first SI message, wherein the first configuration information is configured to indicate that the network device is allowed to send the part of the SIBs in the SI when sending the SI.

In some possible implementations, the transmission module 702 is used to send the first configuration information to the terminal device.

In some possible implementations, the communication apparatus can also be a terminal device (such as UE) in a communication system or a chip or system on chip in the terminal device, and can also be a functional module in the terminal device for implementing the methods of the above-mentioned embodiments. The communication apparatus can implement the functions performed by the terminal device in the above embodiments, and these functions can be implemented by hardware executing corresponding software. These hardware or software includes one or more modules corresponding to the above functions.

Correspondingly, the transmission module 702 is configured to receive at least one system information block (SIB) sent by a network device, wherein the at least one SIB is a part of SIBs in second system information (SI) message, and the second SI message is SI containing a plurality of SIBs configured by the network device.

In some possible implementations, the transmission module 702 is used to send a SI request message to the network device before at least one SIB sent by the network device is received, wherein the SI request message is configured to request the network to send a second SIB; receive the at least one SIB containing the second SIB, wherein the at least one SIB is sent by the network device in response to the SI request message.

In some possible implementations, the SI request message is carried in a radio resource control (RRC) dedicated signaling.

In some possible implementations, the transmission module 702 is used to receive the at least one SIB on a broadcast control channel (BCCH); or, the terminal device receives the at least one SIB on a dedicated control channel (DCCH).

In some possible implementations, the transmission module 702 is used to receive second indication information sent by the network device, wherein the second indication information is configured to indicate a type of the part of the SIBs in the second SI message.

In some possible implementations, second indication information is carried in downlink control information (DCI) configured to schedule the second SI message.

In some possible implementations, the second indication information is carried in a reserved field of the DCI.

In some possible implementations, the terminal device is in a connected state, and the second indication information is carried in a control element of a media access control layer (MAC CE).

In some possible implementations, the transmission module 702 is used to send second capability information to the network device, wherein the second capability information is used to indicate that the terminal device supports the network device to send the part of the SIBs in the SI when sending the SI.

In some possible implementations, the transmission module 702 is used to receive second configuration information from the network device, wherein the second configuration information is configured to indicate that the network device is allowed to send the part of the SIBs in the SI when sending the SI.

It should be noted that the specific implementation process of the processing module 701 and the transmission module 702 can refer to the detailed description of the base station and the UE in the embodiments of FIGS. 2 to 5. For the sake of brevity of the specification, it will not be repeated here.

The transmission module 702 mentioned in the embodiment of the present disclosure can be a transceiver interface, a transceiver circuit or a transceiver, etc.; the processing module 701 can be one or more processors.

Based on the same inventive concept, an embodiment of the present disclosure provides a communication device, which may be a base station or UE described in one or more of the above embodiments. FIG. 8 is a schematic diagram of the structure of a communication device in an embodiment of the present disclosure. As shown in FIG. 8, a communication device 80 uses general computer hardware, including a processor 81, a memory 82, a bus 83, an input device 84, and an output device 85.

In some possible implementations, the memory 82 may include a computer storage medium in the form of a volatile and/or non-volatile memory, such as a read-only memory and/or a random access memory. The memory 82 may store an operating system, an application, other program modules, executable codes, program data, user data, etc.

The input device 84 may be used to input commands and information to the communication device, such as a keyboard or a pointing device, such as a mouse, a trackball, a touchpad, a microphone, a joystick, a game pad, a satellite TV antenna, a scanner, or a similar device. These input devices may be connected to the processor 81 via a bus 83.

The output device 85 can be used to output information to the communication device. In addition to the monitor, the output device 85 can also be other peripheral output devices, such as speakers and/or printing devices, which can also be connected to the processor 81 through the bus 83.

The communication device can be connected to the network through the antenna 86, for example, to a local area network (LAN). In a networked environment, the computer execution instructions stored in the control device can be stored in a remote storage device, not limited to local storage.

When the processor 81 in the communication device executes the executable code or application stored in the memory 82, the communication device executes the communication method on the terminal device side or the network device side in the above embodiments. The specific execution process is referred to the above embodiments, which will not be repeated herein.

In addition, the above memory 82 stores computer execution instructions for implementing the functions of the processing module 701 and the transmission module 702 in FIG. 7. The functions/implementation processes of the processing module 701 and the transmission module 702 in FIG. 7 can be implemented by the processor 81 in FIG. 8 calling the computer execution instructions stored in the memory 82. The specific implementation process and functions refer to the above related embodiments.

Based on the same inventive concept, the embodiment of the present disclosure provides a terminal device, which is consistent with the UE in one or more of the above embodiments. Optionally, the terminal device can be a mobile phone, a computer, a digital broadcast terminal device, a message transceiver device, a game console, a tablet device, a medical device, a fitness device, a personal digital assistant, etc.

In the present disclosure, a network device is configured with a SI message (i.e., a first SI message) containing a plurality of SIBs. When the network device sends the first SI message, it only sends a part of the SIBs in the first SI message. In this way, transmission of unnecessary SIBs is avoided, system resource overhead is reduced, and power consumption of the network device is reduced.

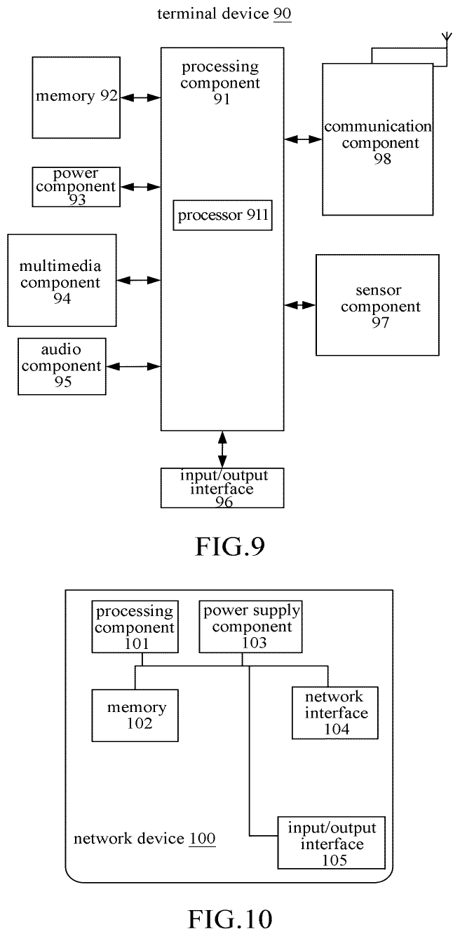

FIG. 9 is a structural schematic diagram of a terminal device in an embodiment of the present disclosure. Referring to FIG. 9, the terminal device 90 may include one or more of the following components: a processing component 91, a memory 92, a power component 93, a multimedia component 94, an audio component 95, an input/output (I/O) interface 96, a sensor component 97, and a communication component 98.

The processing component 91 typically controls the overall operations of the terminal device 90, such as the operations associated with display, telephone calls, data communications, camera operations, and recording operations. The processing component 91 can include one or more processors 911 to execute instructions to perform all or part of the steps in the above methods. Moreover, the processing component 91 can include one or more modules to facilitate the interaction between the processing component 91 and other components. For example, the processing component 91 can include a multimedia module to facilitate the interaction between the multimedia component 94 and the processing component 91.

The memory 92 is configured to store various types of data to support the operation of the terminal device 90. Examples of such data include instructions for any application or method operated on the terminal device 90, such as the contact data, the phone book data, messages, pictures, videos, and the like. The memory 92 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 93 provides power to various components of the terminal device 90. The power component 93 can include a power management system, one or more power sources, and other components associated with the generation, management, and distribution of power in the terminal device 90.

The multimedia component 94 includes a screen providing an output interface between the terminal device 90 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 94 includes a front camera and/or a rear camera. When the terminal device 90 is in an operation mode, such as a photographing mode or a video mode, the front camera and/or the rear camera can receive external multimedia data. Each of the front camera and the rear camera may be a fixed optical lens system or have focus and optical zoom capability.

The audio component 95 is configured to output and/or input an audio signal. For example, the audio component 95 includes a microphone (MIC) configured to receive an external audio signal when the terminal device 90 is in an operation mode, such as a call mode, a recording mode, and a voice recognition mode. The microphone is configured to receive the external audio signal. The received audio signal may be further stored in the memory 92 or sent via the communication component 98. In some embodiments, the audio component 95 also includes a speaker for outputting the audio signal.

The I/O interface 96 provides an interface between the processing component 91 and peripheral interface modules, such as a keyboard, a click wheel, a button, and the like. These buttons may include, but not limited to, a home button, a volume button, a starting button, and a locking button.

The sensor component 97 includes one or more sensors for providing state assessments of various aspects of the terminal device 90. For example, the sensor component 97 can monitor an open/closed state of the terminal device 90, relative positioning of components, such as the display and the keypad of the terminal device 90. The sensor component 97 can also detect a change in position of one component of the terminal device 90 or the terminal device 90, the presence or absence of user contact with the terminal device 90, an orientation, or an acceleration/deceleration of the terminal device 90, and a change in temperature of the terminal device 90. The sensor component 97 can also include a proximity sensor configured to detect the presence of nearby objects without any physical contact. The sensor component 97 can also include a light sensor, such as a CMOS or CCD image sensor, configured to use in imaging applications. In some embodiments, the sensor component 97 can also include an accelerometer sensor, a gyroscope sensor, a magnetic sensor, a pressure sensor, or a temperature sensor.

The communication component 98 is configured to facilitate communication between the terminal device 90 and other devices by wired or wireless manners. The terminal device 90 can access a wireless network adopting a communication standard, such as Wi-Fi, 2G, 3G, 4G, 4G, 5G or a combination thereof. In an example embodiment, the communication component 98 receives broadcast signals or broadcast associated information from an external broadcast management system via a broadcast channel. In an example embodiment, the communication component 98 also includes a near field communication (NFC) module to facilitate short-range communication. For example, the NFC module can adopt radio frequency identification (RFID) technology, infrared data association (IrDA) technology, ultra-wideband (UWB) technology, Bluetooth (BT) technology and other technologies.

In an example embodiment, the terminal device 90 may be implemented with one or more application specific integrated circuits (ASICs), digital signal processors (DSPs), digital signal processing devices (DSPDs), programmable logic devices (PLDs), field programmable Gate arrays (FPGAs), controllers, microcontrollers, microprocessors or other electronic components, to perform the methods described above.

Based on the same inventive concept, an embodiment of the present disclosure provides a network device that is consistent with the base station in one or more of the above embodiments.

FIG. 10 is a schematic diagram of the structure of a network device in an embodiment of the present disclosure. As shown in FIG. 10, the network device 100 may include a processing component 101, which further includes one or more processors, and a memory resource represented by a memory 102 for storing instructions executable by the processing component 101, such as an application. The application stored in the memory 102 may include one or more modules each corresponding to a set of instructions. In addition, the processing component 101 is configured to execute instructions to execute any of the aforementioned methods applied to the network device.

The network device 100 may also include a power supply component 103 configured to perform power management of the network device 100, a wired or wireless network interface 104 configured to connect the network device 100 to a network, and an input/output (I/O) interface 105. The network device 100 may operate an operating system stored in the memory 102, such as Windows Server™, Mac OS X™, Unix™, Linux™, FreeBSD™ or the like.

Based on the same inventive concept, a network device includes: an antenna; a memory; and a processor, which is connected to the antenna and the memory respectively, and is configured to control the transmission and reception of the antenna by executing computer executable instructions stored in the memory, and can implement the system information transmission method on the network device side in one or more of the above embodiments.

Based on the same inventive concept, a terminal device includes: an antenna; a memory; and a processor, which is connected to the antenna and the memory respectively, and is configured to control the transmission and reception of the antenna by executing computer executable instructions stored in the memory, and can implement the system information transmission method on the terminal device side in one or more of the above embodiments.

Based on the same inventive concept, the embodiment of the present disclosure also provides a computer-readable storage medium, in which instructions are stored; when the instructions are executed on a computer, the system information transmission method on the terminal device side or the network device side in one or more of the above embodiments is executed.

Based on the same inventive concept, the embodiment of the present disclosure also provides a computer program or a computer program product, which, when executed on a computer, enables the computer to implement the system information transmission method on the terminal device side or the network device side in one or more of the above embodiments.

Other embodiments of the present disclosure will be apparent to those skilled in the art from consideration of the specification and practice of the present disclosure disclosed herein. The present application is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative only, and the real scope and spirit of the present disclosure is defined by the appended claims.

It should be understood that, the present disclosure is not limited to the precise structures that have been described above and shown in the drawings, and various modifications and changes can be made without departing from the scope thereof. The scope of the present disclosure is limited only by the appended claims.

1. A system information transmission method, comprising:
configuring, by a network device, a first system information (SI) message, wherein the first SI message comprises a plurality of system information blocks (SIBs); and
sending, by the network device, a part of the SIBs in the first SI message.

2. The method according to claim 1, comprising:
sending, by the network device, first indication information, wherein the first indication information is configured to indicate a type of the part of the SIBs in the first SI message.

3. The method according to claim 2, wherein the first indication information is carried in downlink control information (DCI) configured to schedule the first SI message.

4. The method according to claim 3, wherein the first indication information is carried in a reserved field of the DCI or in a control element of a media access control layer (MAC CE).

5. (canceled)

6. The method according to claim 1, wherein a broadcast state of the first SI message is configured as non-broadcasting, or the broadcast state of the first SI message is configured as broadcasting, and the first SI message comprises SIBs other than SIB1 to SIB21 and a positioning SIB (SIBpos).

7. (canceled)

8. The method according to claim 1, wherein the part of the SIBs comprises a first SIB, and the first SIB is an SIB requested by a terminal device in a connected state through a radio resource control (RRC) dedicated signaling.

9. The method according to claim 8, wherein the sending the part of the SIBs in the first SI message comprises:
determining, by the network device, that common search space for transmitting SI is configured on an active band width part (BWP) where the terminal device operates;
broadcasting, by the network device, the part of the SIBs containing the first SIB in response to the RRC dedicated signaling.

10. The method according to claim 1, wherein the sending the part of the SIBs in the first SI message comprises at least one of:
broadcasting, by the network device, the part of the SIBs in the first SI message on a broadcast control channel (BCCH); or,
broadcasting, by the network device, the part of the SIBs in the first SI message on a dedicated control channel (DCCH).

11. The method according to claim 1, wherein before sending the part of the SIBs in the first SI message, the method further comprises:
receiving, by the network device, first capability information from a terminal device, wherein the first capability information is configured to indicate that the terminal device supports the network device to send the part of the SIBs in the first SI message when sending the first SI message;
wherein the sending the part of the SIBs in the first SI message comprises:
sending, by the network device, the part of the SIBs in the first SI message to the terminal device in response to the first capability information.

12. The method according to claim 11, further comprising:
configuring, by the network device, first configuration information, wherein the first configuration information is configured to indicate that the network device is allowed to send the part of the SIBs in the first SI message when sending the first SI message,
wherein the method further comprises:
sending, by the network device, the first configuration information to the terminal device.

13. (canceled)

14. A system information transmission method, comprising:
receiving, by a terminal device, at least one system information block (SIB) sent by a network device, wherein the at least one SIB is a part of SIBs in second system information (SI) message, and the second SI message is SI containing a plurality of SIBs configured by the network device.

15. The method according to claim 14, further comprising:
sending, by a terminal device, an SI request message to the network device, wherein the SI request message is configured to request the network device to send a second SIB;
wherein the terminal device receiving at least one SIB sent by the network device comprises:
receiving, by a terminal device, the at least one SIB containing the second SIB, wherein the at least one SIB is sent by the network device in response to the SI request message.

16. The method according to claim 15, wherein the SI request message is carried in a radio resource control (RRC) dedicated signaling.

17. The method according to claim 14, wherein the receiving at least one SIB sent by the network device comprises:
receiving, by a terminal device, the at least one SIB on a broadcast control channel (BCCH); or,
receiving, by a terminal device, the at least one SIB on a dedicated control channel (DCCH).

18. The method according to claim 14, further comprising:
receiving, by a terminal device, second indication information sent by the network device, wherein the second indication information is configured to indicate a type of the part of the SIBs in the second SI message.

19. The method according to claim 18, wherein the second indication information is carried in downlink control information (DCI) configured to schedule the second SI message, or in a reserved field of the DCI.

20. (canceled)

21. The method according to claim 18, wherein the terminal device is in a connected state, and the second indication information is carried in a control element of a media access control layer (MAC CE).

22. The method according to claim 14, further comprising:
sending, by a terminal device, the first configuration information to the network device, wherein the first configuration information is configured to indicate that the terminal device supports the network device to send the part of the SIBs in the second SI message when sending the second SI message.

23. The method according to claim 14, further comprising:
receiving, by a terminal device, second configuration information from the network device, wherein the second configuration information is configured to indicate that the network device is allowed to send the part of the SIBs in the second SI message when sending the second SI message.

24-25. (canceled)

26. A communication device, comprising:
an antenna;
a memory; and
a processor, connected to the antenna and the memory respectively, configured to control transmission and reception of the antenna by executing computer executable instructions stored on the memory, and capable of implementing:
configuring a first system information (SI) message, wherein the first SI message comprises a plurality of system information blocks (SIBs); and
sending a part of the SIBs in the first SI message.

27. (canceled)
